(19) United States
(12) Patent Application Publication
(10) Pub. No.: US 2024/0064240 A1
(43) Pub. Date: Feb. 22, 2024

(54) TECHNIQUES FOR PAIRING CONTACTS AND AGENTS IN A CONTACT CENTER SYSTEM

(71) Applicant: Afiniti, Ltd., Hamilton (BM)

(72) Inventor: Vikash KHATRI, Alexandria, VA (US)

(73) Assignee: Afiniti, Ltd., Hamilton (BM)

(21) Appl. No.: 18/240,723

(22) Filed: Aug. 31, 2023

Related U.S. Application Data
(63) Continuation of application No. 17/859,796, filed on Jul. 7, 2022, now Pat. No. 11,778,097.
Application No. 17/859,796 is a continuation of application No. 17/242,830, filed on Apr. 28, 2021, now Pat. No. 11,418,651.
Application No. 17/242,830 is a continuation of application No. 17/001,376, filed on Aug. 24, 2020, now Pat. No. 11,019,214.
Application No. 17/001,376 is a continuation of application No. 16/538,288, filed on Aug. 12, 2019, now Pat. No. 10,757,261.

(51) Int. Cl. H04M 3/523

(52) U.S. Cl. CPC H04M 3/5232

(57) ABSTRACT

Techniques for pairing contacts and agents in a contact center system are disclosed. In one particular embodiment, the techniques may be realized as a method for pairing contacts and agents in a contact center system comprising: assigning, by at least one computer processor communicatively coupled to and configured to operate in the contact center system, a contact to an agent based on information associated with a prior interaction of the contact with the contact center system. The assigning of the contact to the agent may result in a less favorable outcome for the contact assigned to the agent and an increase in an overall performance of the contact center system.

### CROSS-REFERENCE TO RELATED APPLICATION

This application is a continuation of U.S. patent application Ser. No. 17/859,796, filed Jul. 7, 2022, which is a continuation of U.S. patent application Ser. No. 17/242,830, filed Apr. 28, 2021, now U.S. Pat. No. 11,418,651, which is a continuation of U.S. patent application Ser. No. 17/001,376, filed Aug. 24, 2020, now U.S. Pat. No. 11,019,214, which is a continuation of U.S. patent application Ser. No. 16/538,288, filed Aug. 12, 2019, now U.S. Pat. No. 10,757,261, each of which is hereby incorporated by reference herein its entirety.

### FIELD OF THE DISCLOSURE

The present disclosure generally relates to contact center systems, more particularly, to techniques for pairing contacts and agents in a contact center system.

### BACKGROUND OF THE DISCLOSURE

A typical task assignment system algorithmically assigns tasks arriving at a task assignment center to agents available to handle those tasks. At times, the task assignment center may be in an “L1 state” and have agents available and waiting for assignment to tasks. At other times, the task assignment center may be in an “L2 state” and have tasks waiting in one or more queues for an agent to become available for assignment. At yet other times, the task assignment system may be in an “L3 state” and have multiple agents available and multiple tasks waiting for assignment. An example of a task assignment system is a contact center system that receives contacts (e.g., telephone calls, internet chat sessions, emails, etc.) to be assigned to agents.

In some typical task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent.

In other typical task assignment centers, a performance-based routing (PBR) strategy for prioritizing higher-performing agents for task assignment may be implemented. Under PBR, for example, the highest-performing agent among available agents receives the next available task. Other PBR and PBR-like strategies may make assignments using specific information about the agents.

“Behavioral Pairing” or “BP” strategies, for assigning tasks to agents, improve upon traditional assignment methods. BP targets balanced utilization of agents while simultaneously improving overall task assignment center performance potentially beyond what FIFO or PBR methods will achieve in practice.

When determining a BP model for a BP strategy, a task assignment system may consider information about its agents and incoming tasks or types of tasks. For example, a contact center system may consider the performance history of each agent, such as an agent's conversion rate in a sales queue, and it may consider customer information about a contact, such as the type of service a customer uses or how many years the customer has had a contract with the company, and other types of data found in a typical customer relationship management (CRM) system.

In some contact center systems, it may be advantageous for a BP model to account for historical information associated with a contact's phone number (e.g., billing telephone number (BTN)). Thus, it may be understood that there may be a need for a BP model that takes into consideration historical information associated with a contact's phone number in order to optimize the overall performance of a contact center system.

### SUMMARY OF THE DISCLOSURE

Techniques for pairing contacts and agents in a contact center system are disclosed. In one particular embodiment, the techniques may be realized as a method for pairing contacts and agents in a contact center system comprising: assigning, by at least one computer processor communicatively coupled to and configured to operate in the contact center system, a contact to an agent based on information associated with a prior interaction of the contact with the contact center system. The assigning of the contact to the agent may result in a less favorable outcome for the contact assigned to the agent and an increase in an overall performance of the contact center system.

In accordance with other aspects of this particular embodiment, the information may include an amount of time that has elapsed since the prior interaction.

In accordance with other aspects of this particular embodiment, the information may include an amount of time that elapsed between the prior interaction and an interaction of the contact with the contact center system that precedes the prior interaction.

In accordance with other aspects of this particular embodiment, the information may include a time duration of the prior interaction.

In accordance with other aspects of this particular embodiment, the information may include an average time duration of the prior interaction and one or more interactions of the contact with the contact center system that precede the prior interaction.

In accordance with other aspects of this particular embodiment, the information may include one or more outcomes from the prior interaction.

In accordance with other aspects of this particular embodiment, the information may include a most common outcome from among the prior interaction and one or more interactions of the contact with the contact center system that precede the prior interaction.

In accordance with other aspects of this particular embodiment, the information may include at least one of a type, a purpose, a context, and a queue of the prior interaction.

In accordance with other aspects of this particular embodiment, the information may include at least one of a most common type, a most common purpose, a most common context, and a most common queue among the prior interaction and one or more interactions of the contact with the contact center system that precede the prior interaction.

In another particular embodiment, the techniques may be realized as a system for pairing contacts and agents in a contact center system comprising at least one computer processor communicatively coupled to and configured to operate in the task assignment system, wherein the at least one computer processor is further configured to perform the steps in the above-described method.

In another particular embodiment, the techniques may be realized as an article of manufacture for pairing contacts and agents in a contact center system comprising a non-transitory processor readable medium and instructions stored on the medium, wherein the instructions are configured to be readable from the medium by at least one computer processor communicatively coupled to and configured to operate in the contact center system and thereby cause the at least one computer processor to operate so as to perform the steps in the above-described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a task assignment center according to embodiments of the present disclosure.

FIG. 2 shows a block diagram of a task assignment system according to embodiments of the present disclosure.

FIG. 3 shows a flow diagram of a contact assignment method according to embodiments of the present disclosure.

### DETAILED DESCRIPTION

A typical task assignment system algorithmically assigns tasks arriving at a task assignment center to agents available to handle those tasks. At times, the task assignment center may be in an “L1 state” and have agents available and waiting for assignment to tasks. At other times, the task assignment center may be in an “L2 state” and have tasks waiting in one or more queues for an agent to become available for assignment. At yet other times, the task assignment system may be in an “L3 state” and have multiple agents available and multiple tasks waiting for assignment. An example of a task assignment system is a contact center system that receives contacts (e.g., telephone calls, internet chat sessions, emails, etc.) to be assigned to agents.

In some traditional task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent. In other traditional task assignment centers, a performance-based routing (PBR) strategy for prioritizing higher-performing agents for task assignment may be implemented. Under PBR, for example, the highest-performing agent among available agents receives the next available task.

The present disclosure refers to optimized strategies, such as “Behavioral Pairing” or “BP” strategies, for assigning tasks to agents that improve upon traditional assignment methods. BP targets balanced utilization of agents while simultaneously improving overall task assignment center performance potentially beyond what FIFO or PBR methods will achieve in practice. This is a remarkable achievement inasmuch as BP acts on the same tasks and same agents as FIFO or PBR methods, approximately balancing the utilization of agents as FIFO provides, while improving overall task assignment center performance beyond what either FIFO or PBR provide in practice. BP improves performance by assigning agent and task pairs in a fashion that takes into consideration the assignment of potential subsequent agent and task pairs such that, when the benefits of all assignments are aggregated, they may exceed those of FIFO and PBR strategies.

Various BP strategies may be used, such as a diagonal model BP strategy or a network flow BP strategy. These task assignment strategies and others are described in detail for a contact center context in, e.g., U.S. Pat. Nos. 9,300,802, 9,781,269, 9,787,841, and 9,930,180, all of which are hereby incorporated by reference herein. BP strategies may be applied in an L1 environment (agent surplus, one task; select among multiple available/idle agents), an L2 environment (task surplus, one available/idle agent; select among multiple tasks in queue), and an L3 environment (multiple agents and multiple tasks; select among pairing permutations).

When determining a BP model for a BP strategy, a task assignment system may consider information about its agents and incoming tasks or types of tasks. For example, a contact center system may consider the performance history of each agent, such as an agent's conversion rate in a sales queue, and it may consider customer information about a contact, such as the type of service a customer uses or how many years the customer has had a contract with the company, and other types of data found in a typical customer relationship management (CRM) system. As explained in detail below, embodiments of the present disclosure relates to task assignment systems that may account for historical information associated with a contact's phone number (e.g., billing telephone number (BTN)) in determining a BP model.

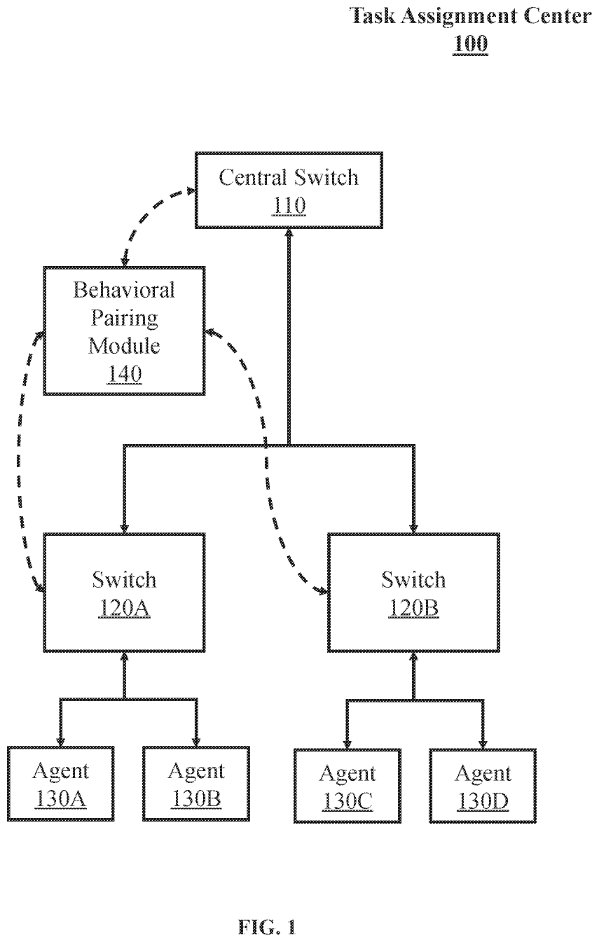

FIG. 1 shows a block diagram of a task assignment center 100 according to embodiments of the present disclosure. The description herein describes network elements, computers, and/or components of a system and method for pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 1, the task assignment center 100 may include a central switch 210. The central switch 110 may receive incoming tasks (e.g., telephone calls, internet chat sessions, emails, etc.) or support outbound connections to contacts via a dialer, a telecommunications network, or other modules (not shown). The central switch 110 may include routing hardware and software for helping to route tasks among one or more subcenters, or to one or more Private Branch Exchange (“PBX”) or Automatic Call Distribution (ACD) routing components or other queuing or switching components within the task assignment center 100. The central switch 110 may not be necessary if there is only one subcenter, or if there is only one PBX or ACD routing component in the task assignment center 100.

If more than one subcenter is part of the task assignment center 100, each subcenter may include at least one switch (e.g., switches 120A and 120B). The switches 120A and 120B may be communicatively coupled to the central switch 110. Each switch for each subcenter may be communicatively coupled to a plurality (or “pool”) of agents. Each switch may support a certain number of agents (or “seats”) to be logged in at one time. At any given time, a logged-in agent may be available and waiting to be connected to a task, or the logged-in agent may be unavailable for any of a number of reasons, such as being connected to another contact, performing certain post-call functions such as logging information about the call, or taking a break. In the example of FIG. 1, the central switch 110 routes tasks to one of two subcenters via switch 120A and switch 120B, respectively. Each of the switches 120A and 120B are shown with two agents each. Agents 130A and 130B may be logged into switch 120A, and agents 130C and 130D may be logged into switch 120B.

The task assignment center 100 may also be communicatively coupled to an integrated service from, for example, a third-party vendor. In the example of FIG. 1, behavioral pairing module 140 may be communicatively coupled to one or more switches in the switch system of the task assignment center 100, such as central switch 110, switch 120A, and switch 120B. In some embodiments, switches of the task assignment center 100 may be communicatively coupled to multiple behavioral pairing modules. In some embodiments, behavioral pairing module 140 may be embedded within a component of the task assignment center 100 (e.g., embedded in or otherwise integrated with a switch).

Behavioral pairing module 140 may receive information from a switch (e.g., switch 120A) about agents logged into the switch (e.g., agents 130A and 130B) and about incoming tasks via another switch (e.g., central switch 110) or, in some embodiments, from a network (e.g., the Internet or a telecommunications network) (not shown). The behavioral pairing module 140 may process this information to determine which tasks should be paired (e.g., matched, assigned, distributed, routed) with which agents.

For example, in an L1 state, multiple agents may be available and waiting for connection to a contact, and a task arrives at the task assignment center 100 via a network or the central switch 110. As explained above, without the behavioral pairing module 140, a switch will typically automatically distribute the new task to whichever available agent has been waiting the longest amount of time for a task under a FIFO strategy, or whichever available agent has been determined to be the highest-performing agent under a PBR strategy. With a behavioral pairing module 140, contacts and agents may be given scores (e.g., percentiles or percentile ranges/bandwidths) according to a pairing model or other artificial intelligence data model, so that a task may be matched, paired, or otherwise connected to a preferred agent.

In an L2 state, multiple tasks are available and waiting for connection to an agent, and an agent becomes available. These tasks may be queued in a switch such as a PBX or ACD device. Without the behavioral pairing module 140, a switch will typically connect the newly available agent to whichever task has been waiting on hold in the queue for the longest amount of time as in a FIFO strategy or a PBR strategy when agent choice is not available. In some task assignment centers, priority queuing may also be incorporated, as previously explained. With a behavioral pairing module 140 in this L2 scenario, as in the L1 state described above, tasks and agents may be given percentiles (or percentile ranges/bandwidths, etc.) according to, for example, a model, such as an artificial intelligence model, so that an agent becoming available may be matched, paired, or otherwise connected to a preferred task.

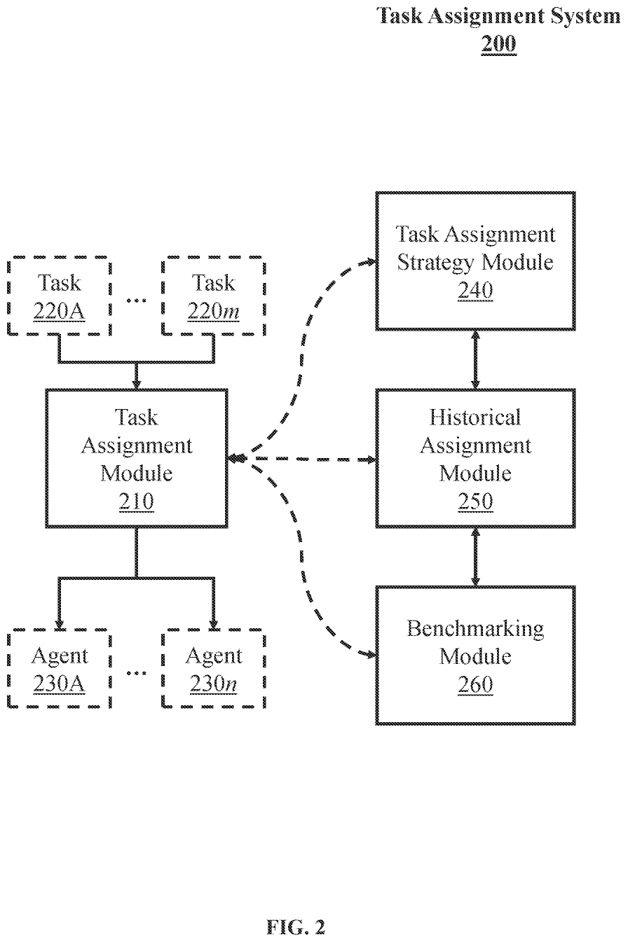

FIG. 2 shows a block diagram of a task assignment system 200 according to embodiments of the present disclosure. The task assignment system 200 may be included in a task assignment center (e.g., task assignment center 100) or incorporated in a component or module (e.g., behavioral pairing module 140) of a task assignment center for helping to assign tasks among various agents.

The task assignment system 200 may include a task assignment module 210 that is configured to pair (e.g., match, assign) incoming tasks to available agents. In the example of FIG. 2, m tasks 220A-220m are received over a given period, and n agents 230A-230n are available during the given period. Each of the m tasks may be assigned to one of the n agents for servicing or other types of task processing. In the example of FIG. 2, m and n may be arbitrarily large finite integers greater than or equal to one. In a real-world task assignment center, such as a contact center, there may be dozens, hundreds, etc. of agents logged into the contact center to interact with contacts during a shift, and the contact center may receive dozens, hundreds, thousands, etc. of contacts (e.g., telephone calls, internet chat sessions, emails, etc.) during the shift.

In some embodiments, a task assignment strategy module 240 may be communicatively coupled to and/or configured to operate in the task assignment system 200. The task assignment strategy module 240 may implement one or more task assignment strategies (or “pairing strategies”) for assigning individual tasks to individual agents (e.g., pairing contacts with contact center agents). A variety of different task assignment strategies may be devised and implemented by the task assignment strategy module 240. In some embodiments, a FIFO strategy may be implemented in which, for example, the longest-waiting agent receives the next available task (in L1 environments) or the longest-waiting task is assigned to the next available agent (in L2 environments). In other embodiments, a PBR strategy for prioritizing higher-performing agents for task assignment may be implemented. Under PBR, for example, the highest-performing agent among available agents receives the next available task. In yet other embodiments, a BP strategy may be used for optimally assigning tasks to agents using information about either tasks or agents, or both. Various BP strategies may be used, such as a diagonal model BP strategy or a network flow BP strategy. See U.S. Pat. Nos. 9,300,802, 9,781,269, 9,787,841, and 9,930,180.

In some embodiments, a historical assignment module 250 may be communicatively coupled to and/or configured to operate in the task assignment system 200 via other modules such as the task assignment module 210 and/or the task assignment strategy module 240. The historical assignment module 250 may be responsible for various functions such as monitoring, storing, retrieving, and/or outputting information about task-agent assignments that have already been made. For example, the historical assignment module 250 may monitor the task assignment module 210 to collect information about task assignments in a given period. Each record of a historical task assignment may include information such as an agent identifier, a task or task type identifier, offer or offer set identifier, outcome information, or a pairing strategy identifier (i.e., an identifier indicating whether a task assignment was made using a BP strategy, a BP strategy, or some other pairing strategy such as a FIFO or PBR pairing strategy).

In some embodiments and for some contexts, additional information may be stored. For example, in a call center context, the historical assignment module 250 may also store information about the time a call started, the time a call ended, the phone number dialed, and the caller's phone number. For another example, in a dispatch center (e.g., “truck roll”) context, the historical assignment module 250 may also store information about the time a driver (i.e., field agent) departs from the dispatch center, the route recommended, the route taken, the estimated travel time, the actual travel time, the amount of time spent at the customer site handling the customer's task, etc.

In some embodiments, the historical assignment module 250 may generate a pairing model, a BP model, or similar computer processor-generated model based on a set of historical assignments for a period of time (e.g., the past week, the past month, the past year, etc.), which may be used by the task assignment strategy module 240 to make task assignment recommendations or instructions to the task assignment module 210.

In some embodiments, the historical assignment module 250 may generate a BP model to account for historical information associated with a contact's phone number (e.g., billing telephone number (BTN)). For example, in the context of a contact center system, based on a contact's phone number, the historical assignment module 250 may include, as a variable or other parameter in the BP model, the amount of time that has elapsed since the contact's prior interaction with the contact center system, an average amount of time elapsed in between the contact's previous interactions with the contact center system, a duration of the contact's previous interaction with the contact center system, and/or an average duration of the contact's previous interactions with the contact center system.

In some embodiments, in a contact center system context, based on a contact's phone number, the historical assignment module 250 may include, as a variable or other parameter in the BP model, one or more outcomes associated with the contact's previous interaction(s) with the contact center system, the most common or average outcome associated with the contact's previous interactions with the contact center system, and/or an indication as to whether the contact's current interaction with the contact center system is the contact's first interaction with the contact center system. A type, purpose, context, queue, etc. of the contact's previous interaction with the contact center system, and/or the most common or average type, purpose, context, queue, etc. of the contact's previous interactions with the contact center system may also be included as a variable or other parameter in the BP model.

As with previously-disclosed BP strategies, a BP strategy, which is based on a BP model that accounts for historical information associated with a contact's phone number, aims at optimizing the overall performance of the contact center system rather than every individual instant contact-agent pairing. For instance, in some embodiments, a particular contact-agent pairing may result in the worst (or less favorable) expected instant outcome for the pairing, but in an increase in expected overall performance of the contact center system. In other embodiments, a particular contact-agent pairing may result in the best expected instant outcome for the pairing, and in an increase in expected overall performance of the contact center system.

In some embodiments, a benchmarking module 260 may be communicatively coupled to and/or configured to operate in the task assignment system 200 via other modules such as the task assignment module 210 and/or the historical assignment module 250. The benchmarking module 260 may benchmark the relative performance of two or more pairing strategies (e.g., FIFO, PBR, BP, etc.) using historical assignment information, which may be received from, for example, the historical assignment module 250. In some embodiments, the benchmarking module 260 may perform other functions, such as establishing a benchmarking schedule for cycling among various pairing strategies, tracking cohorts (e.g., base and measurement groups of historical assignments), etc. Benchmarking is described in detail for the contact center context in, e.g., U.S. Pat. No. 9,712,676, which is hereby incorporated by reference herein.

In some embodiments, the benchmarking module 260 may output or otherwise report or use the relative performance measurements. The relative performance measurements may be used to assess the quality of the task assignment strategy to determine, for example, whether a different task assignment strategy (or a different pairing model) should be used, or to measure the overall performance (or performance gain) that was achieved within the task assignment system 200 while it was optimized or otherwise configured to use one task assignment strategy instead of another.

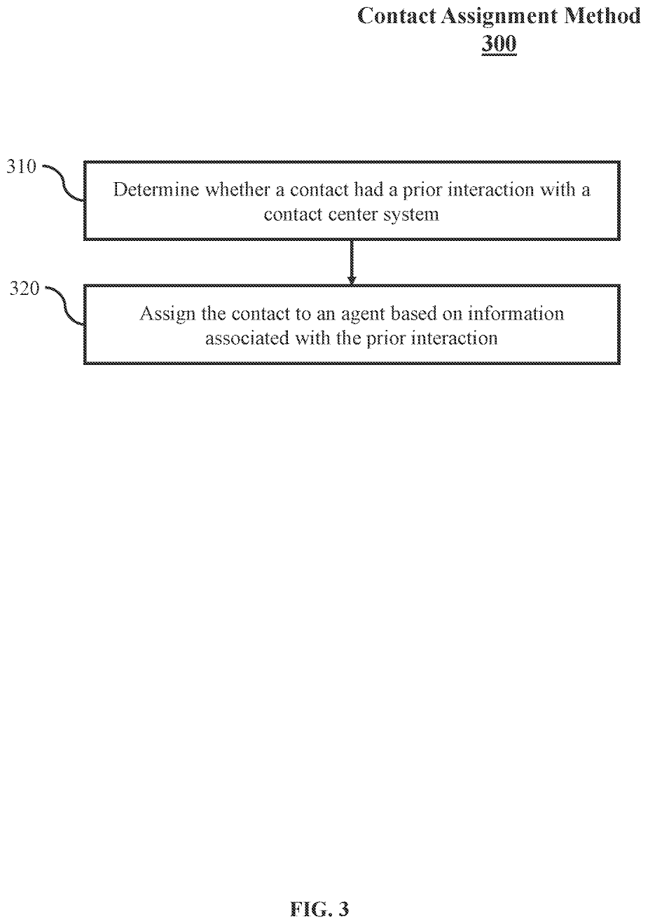

FIG. 3 shows a contact assignment method 300 according to embodiments of the present disclosure. Contact assignment method 300 may begin at block 310. At block 310, the contact assignment method 300 may determine if a contact had a prior interaction with a contact center system (e.g., task assignment system 200). If the contact assignment method 300 determines that the contact had a prior interaction with the contact center system, the contact assignment method 300 may then proceed to block 320. At block 320, the contact assignment method 300 may assign the contact to an agent based on information associated with the prior interaction. In some embodiment, the information associated with the contact's prior interaction may include an amount of time that has elapsed since the contact's prior interaction with the contact center system, an amount of time that elapsed between the contact's prior interaction and an interaction of the contact with the contact center system that precedes the prior interaction, a time duration of the contact's prior interaction, and/or an average time duration of the contact's prior interaction and one or more interactions of the contact with the contact center system that precede the prior interaction. In other embodiments, the information associated with the contact's prior interaction may include one or more outcomes from the prior interaction, and/or a most common outcome from among the prior interaction and one or more interactions of the contact with the contact center system that precede the prior interaction. In yet other embodiments, the information associated with the contact's prior interaction may include a type, a purpose, a context, or a queue of the prior interaction, and/or a most common type, a most common purpose, a most common context, or a most common queue among the prior interaction and one or more interactions of the contact with the contact center system that precede the prior interaction.

At this point it should be noted that task assignment in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1-19. (canceled)

20. A method for pairing contacts and agents in a contact center system comprising:
determining, by at least one computer processor communicatively coupled to and configured to operate in the contact center system, that a contact had a prior interaction with the contact center system; and
assigning, by the at least one computer processor, the contact to an agent based on information associated with the prior interaction;
wherein the assigning results in a particular contact-agent pairing involving the contact and the agent that has a less favorable outcome than another contact-agent pairing involving the contact and another agent, but in an increase in expected overall performance of the contact center system.

21. The method of claim 20, further comprising:
obtaining, by the at least one computer processor, historical contact-agent interaction data for a plurality of contacts, wherein the historical contact-agent interaction data comprises the information associated with the prior interaction with the contact center system.

22. The method of claim 21, further comprising:
determining, by the at least one computer processor, a pairing strategy based on the historical contact-agent interaction data.

23. The method of claim 21, wherein the historical contact-agent interaction data for the plurality of contacts comprises any of: information about a start time for a contact-agent interaction;
information about an end time for a contact-agent interaction; a dialed phone number associated with a contact-agent interaction; and a contact phone number associated with the contact-agent interaction.

24. The method of claim 21, wherein the historical contact-agent interaction data for the plurality of contacts comprises any of: an amount of time that has elapsed since the contact's prior interaction with the contact center system; an average amount of time between the contact's previous interactions with the contact center system; a duration of the contact's previous interaction with the contact center system; and an average duration of the contact's previous interactions with the contact center system.

25. The method of claim 21, wherein the historical contact-agent interaction data for the plurality of contacts comprises any of: one or more outcomes associated with the historical contact-agent interaction data for the contact; and a most common or an average outcome associated with the historical contact-agent interaction data for the contact.

26. The method of claim 21, wherein the historical contact-agent interaction data for the plurality of contacts comprises any of: a type, purpose, context, and/or queue associated with the contact's previous interactions with the contact center system; and a most common or average type, purpose, context, and/or queue of the contact's previous interactions with the contact center system.

27. A system for pairing contacts and agents in a contact center system comprising:
at least one computer processor communicatively coupled to and configured to operate in the contact center system, wherein the at least one computer processor is further configured to:
determine that a contact had a prior interaction with the contact center system; and
assigning the contact to an agent based on information associated with the prior interaction;
wherein the assigning results in a particular contact-agent pairing involving the contact and the agent that has a less favorable outcome than another contact-agent pairing involving the contact and another agent, but in an increase in expected overall performance of the contact center system.

28. The system of claim 27, wherein the at least one computer processor is further configured to:
obtain historical contact-agent interaction data for a plurality of contacts, wherein the historical contact-agent interaction data comprises the information associated with the prior interaction with the contact center system.

29. The system of claim 28, wherein the at least one computer processor is further configured to:
determine a pairing strategy based on the historical contact-agent interaction data.

30. The system of claim 28, wherein the historical contact-agent interaction data for the plurality of contacts comprises any of: information about a start time for a contact-agent interaction; information about an end time for a contact-agent interaction; a dialed phone number associated with a contact-agent interaction; and a contact phone number associated with the contact-agent interaction.

31. The system of claim 28, wherein the historical contact-agent interaction data for the plurality of contacts comprises any of: an amount of time that has elapsed since the contact's prior interaction with the contact center system; an average amount of time between the contact's previous interactions with the contact center system; a duration of the contact's previous interaction with the contact center system; and an average duration of the contact's previous interactions with the contact center system.

32. The system of claim 28, wherein the historical contact-agent interaction data for the plurality of contacts comprises any of: one or more outcomes associated with the historical contact-agent interaction data for the contact; and a most common or an average outcome associated with the historical contact-agent interaction data for the contact.

33. The system of claim 28, wherein the historical contact-agent interaction data for the plurality of contacts comprises any of: a type, purpose, context, and/or queue associated with the contact's previous interactions with the contact center system; and a most common or average type, purpose, context, and/or queue of the contact's previous interactions with the contact center system.

34. An article of manufacture for pairing contacts and agents in a contact center system comprising:
a non-transitory processor readable medium; and
instructions stored on the medium;
wherein the instructions are configured to be readable from the medium by at least one computer processor communicatively coupled to and configured to operate in the contact center system and thereby cause the at least one computer processor to operate so as to:
determine that a contact had a prior interaction with the contact center system; and
assigning the contact to an agent based on information associated with the prior interaction;
wherein the assigning results in a particular contact-agent pairing involving the contact and the agent that has a less favorable outcome than another contact-agent pairing involving the contact and another agent, but in an increase in expected overall performance of the contact center system.

35. The article of manufacture of claim 34, wherein the at least one computer processor is further caused to operate so as to:
obtain historical contact-agent interaction data for a plurality of contacts, wherein the historical contact-agent interaction data comprises the information associated with the prior interaction with the contact center system.

36. The article of manufacture of claim 35, wherein the at least one computer processor is further caused to operate so as to:
determine a pairing strategy based on the historical contact-agent interaction data.

37. The article of manufacture of claim 35, wherein the historical contact-agent interaction data for the plurality of contacts comprises any of: information about a start time for a contact-agent interaction; information about an end time for a contact-agent interaction; a dialed phone number associated with a contact-agent interaction; and a contact phone number associated with the contact-agent interaction.

38. The article of manufacture of claim 35, wherein the historical contact-agent interaction data for the plurality of contacts comprises any of: an amount of time that has elapsed since the contact's prior interaction with the contact center system; an average amount of time between the contact's previous interactions with the contact center system; a duration of the contact's previous interaction with the contact center system; and an average duration of the contact's previous interactions with the contact center system.

39. The article of manufacture of claim 35, wherein the historical contact-agent interaction data for the plurality of contacts comprises any of: one or more outcomes associated with the historical contact-agent interaction data for the contact; and a most common or an average outcome associated with the historical contact-agent interaction data for the contact.

40. The article of manufacture of claim 35, wherein the historical contact-agent interaction data for the plurality of contacts comprises any of: a type, purpose, context, and/or queue associated with the contact's previous interactions with the contact center system; and a most common or average type, purpose, context, and/or queue of the contact's previous interactions with the contact center system.
